(19) United States
(12) Patent Application Publication
(10) Pub. No.: US 2014/0287378 A1
(43) Pub. Date: Sep. 25, 2014

(54) DENTAL CURING LIGHTS AND RELATED METHODS

(71) Applicant: CAO GROUP, Inc., West Jordan, UT (US)

(72) Inventor: Steven D. Jensen, West Jordan, UT (US)

(73) Assignee: CAO GROUP, Inc., West Jordan, UT (US)

(21) Appl. No.: 14/225,171

(22) Filed: Mar. 25, 2014

Related U.S. Application Data
(60) Provisional application No. 61/804,905, filed on Mar. 25, 2013.

(51) Int. Cl. A61C 13/15

(52) U.S. Cl. CPC A61C 19/004
USPC 433/29; 29/592.1

(57) ABSTRACT

Embodiments of the present invention include dental curing lights comprising a battery, and a fire resistant mesh bag at least partially enclosing the battery therein. Additionally, the battery and fire resistant mesh bag may be located within the dental curing light. Additional embodiments of the present invention include methods of manufacturing a dental curing lights. The methods may comprise enclosing a battery within a fire resistant mesh bag, and positioning the battery and fire resistant mesh bag into the dental curing light.

### CROSS-REFERENCE TO RELATED APPLICATIONS

This application claims the benefit of U.S. Provisional Application No. 61/804,905, filed Mar. 25, 2014, titled “Lithium Ion Battery Safety Devices and Related Systems and Methods” which is incorporated herein by reference in its entirety.

### TECHNICAL FIELD OF THE INVENTION

The present invention relates to dental curing lights devices powered by batteries. More specifically, the present invention relates to devices and methods to improve the safety of lithium ion batteries and dental curing lights powered by lithium ion batteries.

### SUMMARY OF THE INVENTION

Embodiments of the present invention include dental curing lights comprising a battery, and a fire resistant mesh bag at least partially enclosing the battery therein. Additionally, the battery and fire resistant mesh bag may be located within the dental curing light.

Additional embodiments of the present invention include methods of manufacturing a dental curing lights. The methods may comprise enclosing a battery within a fire resistant mesh bag, and positioning the battery and fire resistant mesh bag into the dental curing light.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 shows an isometric view of an electronic device and a charging cradle according to an embodiment of the present disclosure.

FIG. 2 depicts an isometric view of a battery and a mesh bag according to an embodiment of the present disclosure.

### DETAILED DESCRIPTION

In various industries, such as the dental industry, there are multiple needs for various electronic devices that are battery operated. Clinicians often prefer a battery operated device to one that is required to be plugged into an electrical outlet by a cord during operation. An electrical cord may be seen as a nuisance, because it limits the freedom to operate the device and must be moved at times to accommodate a new location or position of the device. There are limitations to battery operated electronic devices as well. For example, battery operated electronic devices have a finite time of operation. The operating time of the battery operated electronic device is limited by the charge density and capacity of the battery. Additionally, the battery must be regularly recharged or replaced, whereas an electronic device that utilize power from an electrical cord may be operated continuously.

In order to increase the operational use of portable electronic devices, it warrants a battery with a relatively high charge density that, when in its final manufactured form, takes up a relatively small volume. Many battery half-cell combinations do not have sufficient charge densities to create a useful battery of a practical size for a specific application (e.g., the battery pack becomes too large to be a practical portable device).

Portable dental devices typically require relatively large quantities of power for standard operational use. An example of portable dental devices are portable dental curing lights and hand-held laser devices. These devices require a relatively large quantity of power to operate, and are expected to operate flawlessly throughout the clinicians work day. Accordingly, there is generally only one type of battery with sufficient charge density that is practical for operating these types of electronic dental devices; it is the lithium ion battery. The lithium ion battery is ideal for portable electronic dental devices and is the dominant battery. The lithium ion battery is widely used in almost all contemporary dental electronic devices to date.

Lithium ion batteries do have a major drawback in their design in that the material components that create the battery are thermally unstable and when heated to a sufficient temperature undergo an exothermic process called “thermal runaway.” In a lithium ion battery, both the anode and cathode may begin to exothermically react with electrolytes at temperatures as low as 130 degrees Celsius.

Lithium ion batteries are designed with a fail-safe measure that allows hot volatile electrolytes to vent through a safety vent. The safety vent is plugged with a temperature sensitive wax. The temperature sensitive wax is designed to melt when heated to a specific temperature, and thus allow venting through the safety vent. This fail-safe is designed to protect against the rupture of the battery casing from the expansion forces of hot electrolyte volatile gasses. Nevertheless, the electrolyte venting fail-safe does not prevent a thermal runaway event from occurring, as it is inherent in the design and material remaining after venting has occurred.

It is believed that the major cause of lithium ion thermal runaway is contact between the anode and the cathode. When the anode and cathode come into contact with each other, sufficient heat is produced through electrical resistance to initiate exothermic catastrophic breakdown. Only a thin polyethylene sheet, which may be easily ruptured, separates the anode and cathode of current lithium ion batteries. Therefore, a lithium ion battery that becomes accidentally damaged may be at high risk for thermal runaway. Lithium ion batteries are also known to grow dendrite crystals, which overtime may pierce the polyethylene membrane and result in the disastrous contact between anode and cathode. Accordingly, the risk of a lithium ion battery runaway cannot be mitigated away, because it is inherent within the battery design and materials itself.

Lithium ion batteries may be especially susceptible to thermal runaway when the battery is charging. It is during the charging state that energy is being directed into the half-cells with sufficient voltage and amperage to complete a charge. This addition of energy creates heat that may contribute to a thermal runaway if and when the anode contacts the cathode.

In view of the foregoing, fire resistant containment devices that at least partially enclose a lithium ion battery, especially during and after charging cycles, may improve the safety of the lithium ion battery.

In some embodiments of the present disclosure, a charging cradle includes a device enclosure. The device enclosure may include an inner core of fire resistant, collapsible material that is designed to absorb impact and readily accept hot flying debris by allowing the debris to become safely imbedded and cooled within it. The device enclosure may also include an outer core of hard, durable material that re-enforces the inner core and provides another layer of protection if the inner-core fails to contain higher velocity debris. The entire charging cradle may be designed such that all concussive forces not absorbed by the charging cradle may be directed upward (e.g., towards the ceiling in a direct path).

In additional embodiments, a lithium ion battery may be enclosed in a fire resistant, very durable cloth or mesh bag; which may be designed to retain hot flying debris, while allowing hot expanding gasses to escape.

Below is a non-limiting example of the present technology as it pertains to a dental curing light. It will be understood that, although the present technology is described with reference to a dental curing light, the present technology may be utilized for other battery powered portable electronic devices as well.

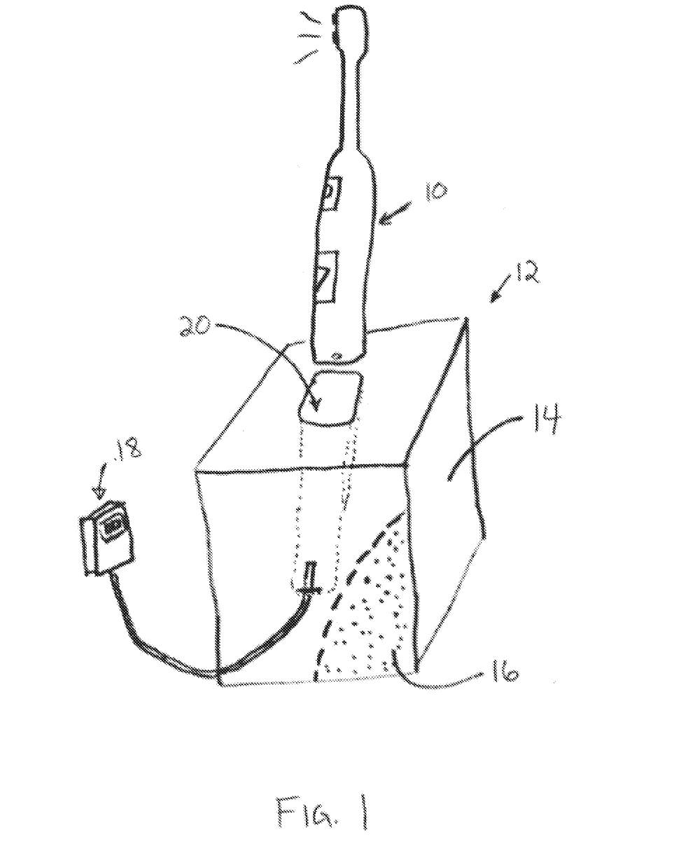

FIG. 1 shows an example of a portable dental curing light 10. The curing light 10 contains a lithium ion battery within the housing, and is recharged by placing an end into a slot 20 of a charging cradle 12. The charging cradle 12 may be powered by a power supply 18 that may be plugged into a conventional wall outlet.

The power supple E may be a permanent fixed to or contained within the charging cradle 12, such that a clinician cannot charge the curing light 10 without insertion into the charging cradle 12. When the curing light 10 is inserted into the slot 20 of the charging cradle 12 it becomes enclosed within two walls 14 and 16. Wall 16 may be an inner core of fire resistant collapsible material that is designed to collapse under impact. Additionally, the material of wall 16 may be designed to capture flying debris. For example, flying debris may become safely imbedded within the material of wall 16. Wall 14 may be configured as an outer sleeve, designed to be strong and rigid in order to re-enforce the weaker inner core material of wall 16. Wall 14 may additionally provide another layer of protection if the material of wall 16 fails to contain higher velocity debris. The slot 20 of the charging cradle 12 may be the only opening of the charging cradle and it may be designed to be vertical. The vertical orientation of the slot 20 of the charging cradle 12 may direct the ejection of any debris (such as components of the curing light 10) upwards, towards the ceiling.

In additional embodiments, the charging cradle 12 may be configured with a single wall of material, or many walls, as needed for the particular device in question.

The collapsible material of wall 16 may be comprised of rigid foams, similar to polystyrene foams. The rigid foams may be made to be fire resistant. For example, an additive (e.g., hexabromo cyclododecane) may be added to polystyrene foam to provide a fire resistant rigid foam.

A non-limiting example of an inner core material would be fire resistant polystyrene foam. Polystyrene foam is a light formable rigid material that may collapse upon impact. Polystyrene foam may also be sufficiently soft so that it may be punctured easily. Fire resistant polystyrene foam may be capable of collapsing upon impact, thus absorbing the impact of flying debris. Fire resistant polystyrene foam may also be punctured and/or melted easily by hot or cold flying debris and therefore contain the debris therein. Fire resistant polystyrene foam may safely imbed hot debris therein and allow the debris to cool without starting a secondary fire.

The fire resistant foam may define the slot 20 of the charging cradle 12, so that there are no structures positioned between the fire resistant foam of the wall 16 and the curing light 10 when charging. Additionally, the slot 20 may be sized with a sufficient depth, so that the batteries within the curing light 10 are positioned completely within the slot 20 when charging. Accordingly, the batteries within the device 10 may be surrounded by the walls 14 and 16.

The rigid outer sleeve of wall 14 may be comprised of a strong, durable material such as one or more of a rigid plastic, a fiber imbedded plastic, ceramic fiber, glass fiber, silicone, a metal, and any other similar materials.

In some embodiments, the rigid outer sleeve of wall 14 may be comprised of one or more of polyethylene, ABS, polypropylene, and nylon; as these materials are relatively strong and rigid, and are less expensive than metal. These materials can be furthered strengthened by the addition of fibers within the polymer for improved characteristics. The addition of fire resistance may also be warranted for materials that are otherwise capable of combustion. Examples of metals that may be utilized for the rigid outer sleeve of wall 14 include aluminum and sheet steel, as well as any other similar materials.

The vertical slot 20 of the charging cradle 12 may be designed without any angles other than vertical. This design may direct un-captured flying debris harmlessly towards the ceiling and away from bystanders that may be located near the charging cradle 12.

The enclosure of the charging cradle 12 may be designed with a single material or many materials depending on the specific electronic portable device in question. Some devices utilize many batteries for operation and thus have a possible greater thermal runaway event that must be accounted for in the specific design.

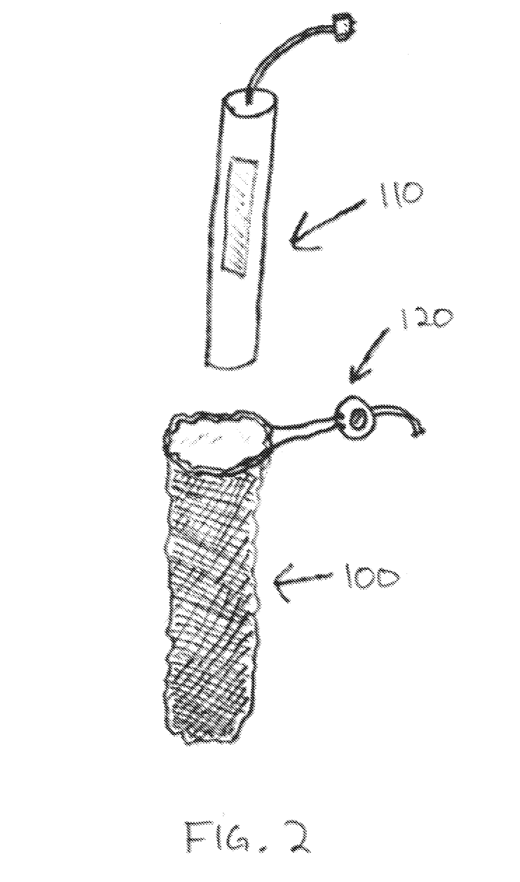

In additional embodiments of the present disclosure, as shown in FIG. 2, a fire resistant durable cloth or mesh bag 100 may be configured to partially or fully enclose a lithium ion battery 110. The mesh bag 100 may be designed to capture hot flying debris in the event the battery 110 undergoes a thermal runaway; and, at the same time, the mesh bag 100 may allow hot expansive gasses to escape therethrough.

The mesh bag 100 may be designed to incorporate the Davy's safety lamp effect, such that the mesh openings are sufficiently small as to not allow a flame to propagate through the mesh bag 100 to ignite materials outside of the mesh bag 100. The mesh bag 100 may be woven, fused, or knitted from fiber(s) from various materials such as one or more of fire resistant plastic, fiber filled plastic, ceramic fiber, glass fiber, carbon fiber, graphite, silicone, metal and any other useful materials. Those fibers not fire resistant can be blended with fire retardant additives to make them fire resistant. Additives such as graphite, carbon black, hexabromo cyclododecane, and many other fire retardant additives can be selected to impart fire resistant properties. The fiber materials may be selected that are strong, durable and fire resistant, examples of materials are: Stainless steel, Kevlar, black Kevlar, fire resistant Kevlar, fire resistant high density polyethylene and polypropylene, ceramic fiber, glass fiber, zirconia fiber, silica fiber, aluminum oxide fiber, alumina silicate fiber, boroalumina silicate fiber, zirconia silicate fiber, porcelain fiber, and any other useful materials.

The battery 110 may be a common lithium ion battery type, though other designs and types are possible. The battery 110 may be fitted internally into an electronic device. The battery 110 may be first placed into the fire resistant mesh bag 100. A drawstring 120 may then be utilized to snugly enclose the battery 110 within the mesh bag 100, while allowing an outlet for wires extending from the battery 110. Finally the battery 110 and mesh bag 100 assembly may be fitted and connected into a desired electronic device.

In view of the foregoing, embodiments of the present disclosure may provide multiple layers of protection from: fire, concussive forces, hot gasses, and flying debris. Additionally, embodiments of the present disclosure may be built into any given device in order to prevent injury. For example, the mesh bag 100 may be utilized in the curing light 10 (see FIG. 1) and in the event of a thermal runaway, the fire resistant mesh bag 100 that encloses the battery 110 may capture hot flying debris, extinguish flame and allow hot expansive gasses to escape into the curing light 10.

In some cases, the fire resistant mesh bag 100 may be sufficient protection. In the event that the concussive forces and/or expansive gasses become too great for the mesh bag 100, and the mesh bag 100 ruptures or causes the rupture of the electronic device itself, then the charging cradle 12 may become a secondary line of defense.

The heat resistant collapsible foam of Wall 16 may be designed to receive both hot and cold flying debris. Cold debris will be imbedded into the foam as it may puncture the foam relatively easily. Hot debris may simply melt into the foam until it cools sufficiently to become immobile and imbedded. Exposure to open flame may be diminished, because the foam may be resistant to burning and may char instead of burning. Concussive forces may be absorbed as the foam collapses. Finally if all the above protection layers of the wall 16 fail, the durable and hard outer sleeve of wall 14 is designed to catch any remaining higher velocity or hot flying debris.

The present invention may be embodied in various other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dental curing light, comprising:
a battery; and
a fire resistant mesh bag at least partially enclosing the battery therein; and
wherein the battery and fire resistant mesh bag are located within the dental curing light.

2. The dental curing light of claim 1, wherein the battery comprises a lithium ion battery.

3. The dental curing light of claim 1, wherein each mesh opening of the fire resistant mesh bag is sufficiently small as to not allow a flame to propagate therethrough.

4. The dental curing light of claim 1, wherein the fire resistant mesh bag is comprised of woven fibers.

5. The dental curing light of claim 1, wherein the fire resistant mesh bag is comprised of knitted fibers.

6. The dental curing light of claim 1, wherein the fire resistant mesh bag is comprised of fused fibers.

7. The dental curing light of claim 1, wherein the fire resistant mesh bag is comprised of fibers selected from the group of fibers consisting of fire resistant plastic, fiber filled plastic, ceramic fiber, glass fiber, carbon fiber, graphite, silicone, and metal.

8. The dental curing light of claim 1, wherein the fire resistant mesh bag is comprised of fibers selected from the group of fibers consisting of stainless steel, Kevlar, black Kevlar, fire resistant Kevlar, fire resistant high density polyethylene and polypropylene, ceramic fiber, glass fiber, zirconia fiber, silica fiber, aluminum oxide fiber, alumina silicate fiber, boroalumina silicate fiber, zirconia silicate fiber, and porcelain fiber.

9. The dental curing light of claim 8, wherein the fibers are blended with a fire retardant additive.

10. The dental curing light of claim 9, wherein the fire retardant additive is comprised of at least one of graphite, carbon black, and hexabromo cyclododecane.

11. A method of manufacturing a dental curing light, the method comprising:
enclosing a battery within a fire resistant mesh bag; and
positioning the battery and fire resistant mesh bag into the dental curing light.

12. The method of claim 11, wherein enclosing the battery within the fire resistant mesh bag comprises enclosing a lithium ion battery within the fire resistant mesh bag.

13. The method of claim 11, wherein each mesh opening of the fire resistant mesh bag is sufficiently small as to not allow a flame to propagate therethrough.

14. The method of claim 11, wherein the fire resistant mesh bag is comprised of woven fibers.

15. The method of claim 11, wherein the fire resistant mesh bag is comprised of knitted fibers.

16. The method of claim 11, wherein the fire resistant mesh bag is comprised of fused fibers.

17. The method of claim 11, wherein the fire resistant mesh bag is comprised of fibers selected from the group of fibers consisting of fire resistant plastic, fiber filled plastic, ceramic fiber, glass fiber, carbon fiber, graphite, silicone, and metal.

18. The method of claim 11, wherein the fire resistant mesh bag is comprised of fibers selected from the group of fibers consisting of stainless steel, Kevlar, black Kevlar, fire resistant Kevlar, fire resistant high density polyethylene and polypropylene, ceramic fiber, glass fiber, zirconia fiber, silica fiber, aluminum oxide fiber, alumina silicate fiber, boroalumina silicate fiber, zirconia silicate fiber, and porcelain fiber.

19. The method of claim 18, wherein the fibers are blended with a fire retardant additive.

20. The method of claim 19, wherein the fire retardant additive is comprised of at least one of graphite, carbon black, and hexabromo cyclododecane.
